(19) United States
(12) Patent Application Publication
(10) Pub. No.: US 2026/0179381 A1
(43) Pub. Date: Jun. 25, 2026

(54) BODY WORN CAMERA AND METHOD FOR RECORDING VIDEO CAPTURED THEREFROM

(71) Applicant: MOTOROLA SOLUTIONS, INC., CHICAGO, IL (US)

(72) Inventors: BOON HOO TEE, GELUGOR (MY); SU SIEW SOH, SUNGAI ARA (MY); ANITA LEE, BAYAN LEPAS (MY); CHIN CHIN OOI, GEORGETOWN (MY); YIN HSIAN KOH, PENANG (MY)

(21) Appl. No.: 18/989,034

(22) Filed: Dec. 20, 2024

(51) Int. Cl. G06V 20/40; G06F 16/783

(52) U.S. Cl. CPC G06V 20/46; G06F 16/7834; G06V 20/44

(57) ABSTRACT

A Body Worn Camera (BWC) and method for recording video captured therefrom is disclosed. The method includes operating the BWC's image sensor to capture video. The method also includes temporarily storing, in a first storage medium, at least a portion of the video as pre-record video. The method also includes initiating a first stage of recording in response to detection of an occurrence of at least one first trigger at a first time, and initiating a second stage of recording in response to detecting or registering an occurrence of at least one second trigger at a second time later than the first time. At a third time after the second time, when there is an absence of a valid stop record request during a period of time in-between the first time and the third time, a number of portions of the pre-record video become persistently stored.

### BACKGROUND

On-duty police officers and security guards are often equipped with Body Worn Cameras (BWCs) to capture on-scene video, thereby enhancing available information and evidence associated with incidents at which the officers and guards make an attendance. In some BWCs, a user must press a button on the camera to start recording. In other BWCs, the pressing of a button is not necessarily required, and instead BWC recording can start based on something other than the pressing of a button having occurred. Such recording initiation functionality in a BWC is sometimes referred to as automatic activation.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a body worn camera in accordance with example embodiments.

FIG. 2 is a flow chart illustrating a method in accordance with an example embodiment.

FIG. 3 is a block diagram showing first example details illustrative of video recording triggers in accordance with an example embodiment.

FIG. 4 is a block diagram showing second example details illustrative of video recording triggers in accordance with an example embodiment.

Skilled artisans will appreciate that elements in the figures are illustrated for simplicity and clarity and have not necessarily been drawn to scale. For example, the dimensions of some of the elements in the figures may be exaggerated relative to other elements to help improve an understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In accordance with one example embodiment, there is provided a body worn camera that includes a body worn camera that includes an image sensor configured to capture video. The body worn camera also includes a first storage medium configured to temporarily store at least a portion of the video as pre-record video. The body worn camera also includes a second storage medium configured to persistently store some portions of the pre-record video. The body worn camera also includes at least one processor configured to: initiate a first stage of recording in response to detection of an occurrence of at least one first trigger at a first time; initiate a second stage of recording in response to detecting or registering an occurrence of at least one second trigger at a second time later than the first time; and cause the portions of the pre-record video to become persistently stored at a third time after the second time when there is an absence of a valid stop record request during a period of time in-between the first time and the third time. During the first stage defined one or more of a first plurality of actions will produce the valid stop request. During the second stage defined one or more of a second plurality of actions will produce the valid stop request. At least one of the one or more of a first plurality of actions will not produce the valid stop request during the second stage.

In accordance with another example embodiment, there is provided a method that includes operating an image sensor of a Body Worn Camera (BWC) to capture video. The method also includes temporarily storing, in a first storage medium, at least a portion of the video as pre-record video. The method also includes initiating, using an at least one processor, a first stage of recording in response to detection of an occurrence of at least one first trigger at a first time. The method also includes initiating, using the at least one processor, a second stage of recording in response to detecting or registering an occurrence of at least one second trigger at a second time later than the first time. The method also includes causing a number of portions of the pre-record video to become persistently stored, in a second storage medium, at a third time after the second time when there is an absence of a valid stop record request during a period of time in-between the first time and the third time. During the first stage defined one or more of a first plurality of actions will produce the valid stop request. During the second stage defined one or more of a second plurality of actions will produce the valid stop request. At least one of the one or more of a first plurality of actions will not produce the valid stop request during the second stage.

Each of the above-mentioned embodiments will be discussed in more detail below, starting with example system and device architectures of the system in which the embodiments may be practiced, followed by an illustration of processing blocks for achieving an improved technical method, device, and system for recording BWC-captured video.

Example embodiments are herein described with reference to flowchart illustrations and/or block diagrams of methods, apparatus (systems) and computer program products according to example embodiments. It will be understood that at least some blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

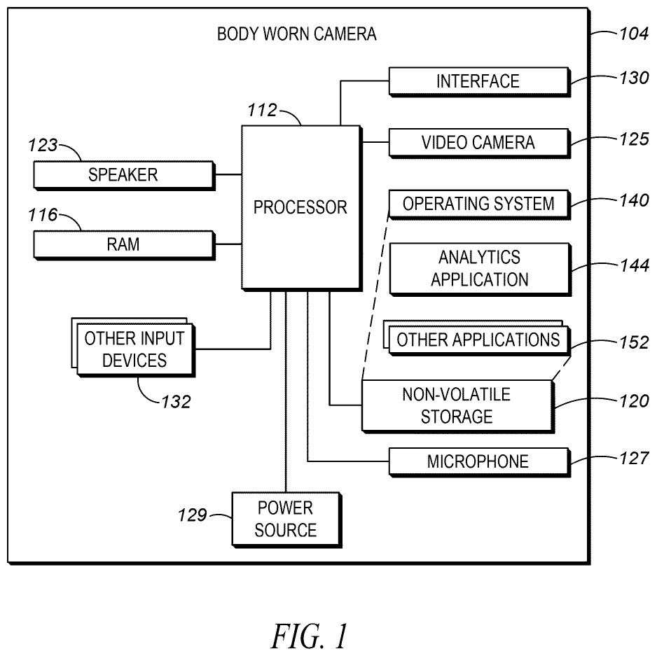

Referring now to the drawings, and in particular FIG. 1 which is a block diagram of a body worn camera 104 within which methods in accordance with example embodiments can be carried out. In some example embodiments, the Body Worn Camera (BWC) 104 is, for example, a dedicated BWC device or, alternatively, a mobile electronics device that can be body worn (with a suitable body attachment accessory) such as, for example, a tablet, a phablet, a smart phone or a personal digital assistant (PDA). Certain components of the BWC 104 which may be present in some examples such as, for instance, a small display screen integrated into the BWC, are not illustrated in FIG. 1 because their inclusion or non-inclusion is not impacting an understanding of example embodiments.

The illustrated body worn camera 104 includes at least one processor 112 that controls the overall operation of the body worn camera. The processor 112 interacts with various subsystems such as, for example, random access memory (RAM) 116, non-volatile storage 120, speaker 123, video camera 125 (core camera components including lens assembly and image sensor), and microphone 127. The speaker 123 turns electrical audio signals into acoustical sound waves that a person can hear. The microphone 127 captures audio from which audio metadata may be generated.

Continuing on, in some examples the video camera 125 may be optionally integrated into a housing of the body worn camera 104 (any suitable device components like, for instance, the speaker 123 and the microphone 127, may be optionally integrated into the housing of the BWC 104). Also, those skilled in the art will appreciate that some of the illustrated device components of the body worn camera 104 are optional device components such as, for example, the speaker 123 and the microphone 127.

The illustrated body worn camera 104 also includes a power source 129 which provides operating power within the body worn camera 104. In some examples, the power source 129 includes one or more batteries, a power supply with one or more transformers, etc.

The illustrated body worn camera 104 also includes interface 130. The interface 130 may include hardware, software, or both providing one or more interfaces for communication (such as, for example, packet-based communication) among the body worn camera 104, other computing devices similar to the body worn camera 104, any suitable networks, any suitable network devices, and/or any other suitable computer systems. As an example and not by way of limitation, the interface 130 may include a Network Interface Controller (NIC) or network adapter for communicating with an Ethernet or other wire-based network and/or a Wireless NIC (WNIC) or wireless adapter for communicating with a wireless network. In at least one example consistent with the example embodiment of FIG. 1, the interface 130 may include a USB port to support USB-compliant communications.

In some examples, the interface 130 comprises one or more radios coupled to one or more physical antenna ports. Depending on the example implementation, the interface 130 may be any type of interface suitable for any type of suitable network with which the body worn camera 104 is used. As an example and not by way of limitation, the body worn camera 104 can communicate with an ad-hoc network, a Personal Area Network (PAN), a Local Area Network (LAN), a Wide Area Network (WAN), a Metropolitan Area Network (MAN), or one or more portions of the Internet or a combination of two or more of these. One or more portions of one or more of these networks may be wireless. As an example, the body worn camera 104 may be capable of communicating with a Wireless PAN (WPAN) (such as, for example, a BLUETOOTH WPAN), a WI-FI™ network, a WI-MAX™ network, a Long-Term Evolution (LTE) network, an LTE-A network, a cellular telephone network (such as, for example, a Global System for Mobile Communications (GSM) network), or any other suitable wireless network or a combination of two or more of these. The body worn camera 104 may include any suitable interface 130 for any one or more of these networks, where appropriate.

In some examples, the interface 130 may include one or more interfaces for one or more external I/O devices. These external I/O devices may include, for instance, a selected one or more of a keyboard, mouse, touch pad and roller ball, etc. An external I/O device may, and not by way of limitation, be any suitable input or output device, including alternatives more external in nature than other input devices (or output devices) herein mentioned (also, some combination of two or more of these is also contemplated). An external I/O device may include one or more sensors. Particular examples may include any suitable type and/or number of I/O devices and any suitable type and/or number of interfaces 130 for them. Where appropriate, the interface 130 may include one or more drivers enabling the processor 112 to drive one or more of these external I/O devices. The interface 130 may include one or more interfaces 130, where appropriate.

The illustrated body worn camera 104 also includes other input devices 132. Examples of other input devices include a start record button, a stop record button, and a combined start/stop record button (as an alternative to separate start and stop record buttons). In at least one example, the body worn camera 104 may include a start record button without any input button that directly stops recording.

Still with reference to the body worn camera 104, operating system 140 and various software applications used by the processor 112 are stored in the non-volatile storage 120. The non-volatile storage 120 is, for example, one or more hard disks, solid state drives, or some other suitable form of computer readable medium that retains recorded information after the body worn camera 104 is turned off. Regarding the operating system 140, this includes software that manages computer hardware and software resources of the body worn camera 104 and provides common services for computer programs. Also, those skilled in the art will appreciate that the operating system 140, analytics application 144, and other applications 152, or parts thereof, may be temporarily loaded into a volatile store such as the RAM 116. The processor 112, in addition to its operating system functions, can enable execution of the various software applications on the body worn camera 104.

Regarding the analytics application 144, its functionality includes carrying out video and/or audio analytics. In some examples, the analytics application 144 may include one or more suitable learning machines to facilitate the video and/or audio analytics. Those skilled in the art will appreciate that the analytics application 144 need not necessarily reside within the body worn camera 104, and instead one alternative may be implementing similarly purposed analytics outside of the body worn camera 104 such as, for example, within one or more servers. Also, in at least one example, the analytics application 144 may operationally execute on live BWC video streams with comparison to video footages and/or media stored in non-volatile or volatile storage.

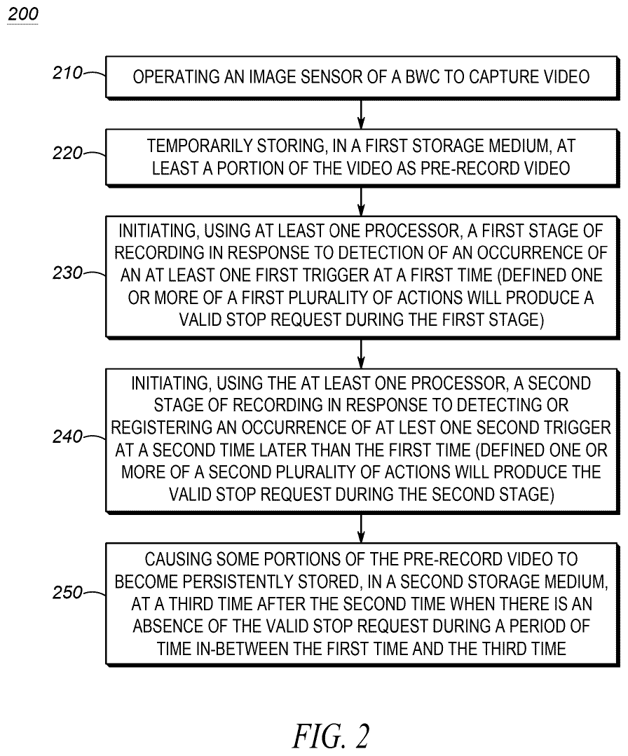

Reference is now made to FIG. 2. FIG. 2 is a flow chart illustrating a method 200 in accordance with an example embodiment.

In FIG. 2, the illustrated method 200 includes operating (210) an image sensor of a Body Worn Camera (BWC) to capture video.

Next in the method 200, action 220 is temporarily storing, in a first storage medium, at least a portion of the video as pre-record video.

Next in the method 200, a first stage of recording is initiated (230) using an at least one processor. The initiating of this first stage of recording is in response to detection of an occurrence of at least one first trigger at a first time. A trigger in the context of the present disclosure may be, for example, an output generated from operation of one or more neural networks that are configured to process video, audio and/or other sensor data received in real-time (or near real-time) while a BWC is in operation. In at least one example, at least one processor may be configured to implement the one or more neural networks to carry out, amongst other possibilities, video analytics on the video to generate video metadata that is repeatedly evaluated over time in order to assess whether one or more triggers have occurred. The BWC 104 illustrated in FIG. 1 includes the analytics application 144 that may include a video analytics component that includes functionality corresponding to the above described functionality. Also, it will be understood that not necessarily a single event detected by one particular sensor will in and of itself result in trigger occurrence, rather instead it is contemplated that some combination of a plurality of detected live events may effect certain triggers (with not all triggers necessarily being similarly effected).

In addition to video, audio may also be analyzed (for example, by an audio analytics component of the analytics application 144) in evaluating the conditions for a trigger. In at least one example, evaluating audio metadata (which may be in addition to any of the above-described evaluating of the video metadata) may be carried out in assessing whether one or more triggers may have occurred.

In some examples, a first trigger that is a prerequisite to the first stage of recording may include an activation signal from an automatic activation sensor enabling automatic activation of the BWC. Examples of automatic activation sensors include a sensor device that detects a person's weapon being drawn and a sensor device that detects emergency lights of a vehicle being turned on. Also, it is contemplated that the occurrence of the first trigger may, in some examples, cause a duration of some initially defined pre-record time to increase. For instance, if say the default pre-record time of the BWC 104 is set to 120 seconds, the occurrence of a first trigger might extend the pre-record time to 120 seconds plus a delta time between the occurrences in time of the first trigger and occurrence in time of the second trigger (assuming that delta time is not such that a maximum pre-record time would be exceeded). Also, when video recording is occurring, it is contemplated that the BWC 104 may provide some perceptible indication of this. For example, there may be an indication by way of an LED light, an emitted noise, etc.

During the above-mentioned first stage of recording, defined one or more of a first plurality of actions will produce a valid stop request. As an example of the first plurality of actions to produce the valid stop request, the BWC may include a stop button which, when depressed, may constitute a valid stop request during the first stage of recording (however it is also contemplated that, in at least one example, the BWC may not include a stop button). As another example of the first plurality of actions, analytics of captured video and/or audio by the analytics application 144 of the BWC 104 may, after an accidental pressing of the BWC record button, automatically determine, with some pre-defined degree of confidence, that the video and/or audio indicates an accidental record button pressing occurred. An impact of the latter described automatic functionality is preventing capturing of unnecessary video that would, for example, consume an on-board storage resource or, in the case where the start/stop recording is incorporated into a single BWC button, preventing another accidental occurrence where the wearer of the BWC intends to initiate a video recording, but actually causes video recording to be stopped.

Next in the method 200, a second stage of recording is initiated (240) using the at least one processor. The initiating of this second stage of recording is in response to detecting or registering an occurrence of at least one second trigger at a second time later than the first time. During the second stage defined one or more of a second plurality of actions will produce the valid stop request. In at least one example, each of the one or more second plurality of actions, as compared to each of the first plurality of actions, requires a higher authorization level to be carried out (or stricter requirements exist for the action occur). For example, to the extent that a stop record button might exist, simply pressing the stop record button on the BWC 104 might, in and of itself, be insufficient after the second trigger has occurred. Instead a second action might require a combination of sub-actions such as, for example, pressing of the stop record button plus (i.e. in combination with) a determination by the analytics application 144 that evaluated sensor data supports record stopping.

Next in the method 200, a number of portions of the pre-record video are caused (250) to become persistently stored, in a second storage medium, at a third time after the second time when there is an absence of a valid stop record request during a period of time in-between the first time and the third time.

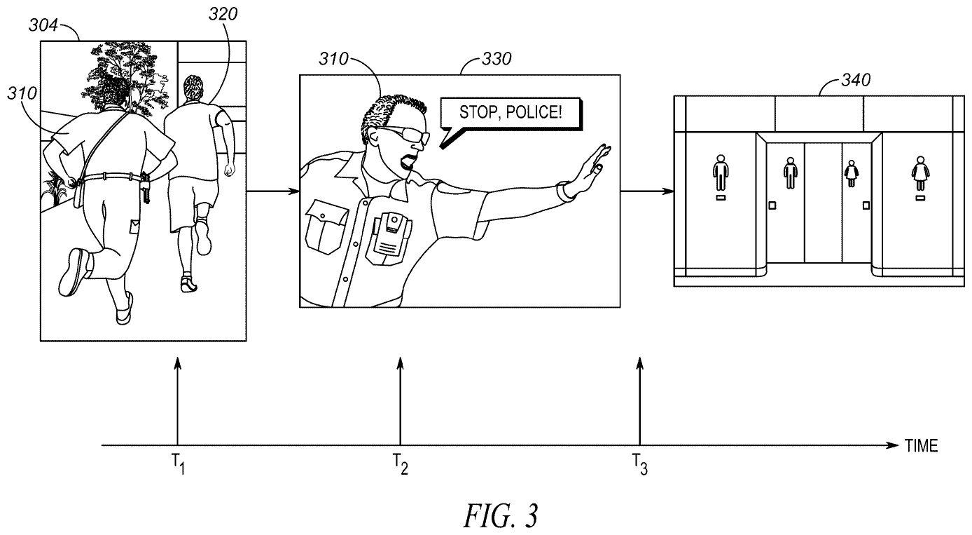

Reference is now made to FIG. 3. FIG. 3 is a block diagram showing first example details illustrative of video recording triggers in accordance with an example embodiment.

In FIG. 3 illustrated time t1 corresponds to an occurrence of a first trigger (“first trigger” having been mentioned previously in respect of the method 200 of FIG. 2 that has been described and illustrated). Surrounding environment depiction 304 is aligned with the time t1. In the surrounding environment depiction 304, a police officer 310 is running after a suspect 320. Detection of the running (by employing, for example, an accelerometer in the BWC or a heart rate sensor attached to the police officer 310 that communicates with the BWC) may be registered as an event that causes the first trigger to occur.

Next, illustrated time t2 corresponds to an occurrence of a second trigger (“second trigger” having been mentioned previously in respect of the method 200 of FIG. 2 that has been described and illustrated). Surrounding environment depiction 330 is aligned with the time t2. In the surrounding environment depiction 330, the police officer 310 is shouting. Detection of the shouting (by way of, for example, an audio analytics component of the analytics application 144) may be registered as an event that causes the second trigger to occur.

Next, illustrated time t3 corresponds to a third time after the second time (discussed previously in connection with the method 200). Post-time t3 persistent storage of video captured is occurring; however, there will be one of the second plurality of actions (discussed previously in connection with the method 200) to stop recording of video after the chase of the suspect 320 reaches a point where the officer needs to enter a public washroom facility (i.e. surrounding environment depiction 340). In particular, generally speaking a washroom facility is a place where there is an expectation of increased privacy rights (e.g. certain rights not to be video recorded or otherwise have one's privacy potentially transgressed).

As an alternative to no recording at all of any video within the public washroom facility, in at least one example a portion of captured video corresponding to video recording with the public washroom facility may be assigned a high severity level amongst a plurality of severity levels assigned to different portions of captured video. This high severity level may, in terms of ability to access recorded video, correspond to higher credentials (i.e. higher than a user of the BWC by himself possesses).

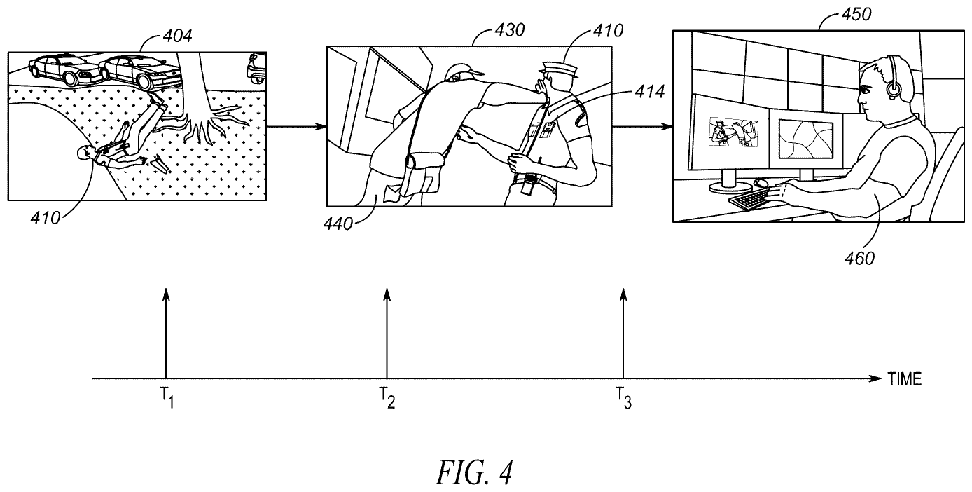

Reference is now made to FIG. 4. FIG. 4 is a block diagram showing second example details illustrative of video recording triggers in accordance with an example embodiment.

In FIG. 4 illustrated time t1 corresponds to an occurrence of a first trigger (“first trigger” having been mentioned previously in respect of the method 200 of FIG. 2 that has been described and illustrated). Surrounding environment depiction 404 is aligned with the time t1. In the surrounding environment depiction 404, a police officer 410 falls down to the ground. Detection of the falling (by employing, for example, an accelerometer or a gyroscope in BWC 414, or in another device like a two-way radio of the police officer 410 that communicates with the BWC 414) may be registered as an event that causes the first trigger to occur.

In the illustrated scenario, there may be activity after the time t1 but before the time t2. For example, the lens of the BWC may become covered up by reason of the police officer's position (e.g. lying on his stomach) or for some other reason (for instance, another person deliberately covering the lens with a hand or a piece of tape). In such circumstances, it is contemplated that the speaker 123 of the BWC 104 might emit an audible message alerting of the existence of the obstruction and the need to restore to a previous non-obstructed state.

Next, the illustrated time t2 corresponds to an occurrence of a second trigger (“second trigger” having been mentioned previously in respect of the method 200 of FIG. 2 that has been described and illustrated). Surrounding environment depiction 430 is aligned with the time t2. In the surrounding environment depiction 430, the police officer 410 is fighting with a perpetrator 440. Detection of the fighting (by way of, for example, an video analytics component of the analytics application 144) may be registered as an event that causes the second trigger to occur.

Next, illustrated time t3 corresponds to a third time after the second time (discussed previously in connection with the method 200). Post-time t3 persistent storage of video captured is occurring; however, there will be one of the second plurality of actions (discussed previously in connection with the method 200) to stop recording of video after a point where the fighting has finished, the perpetrator 440 has fled (or has been transported away after an arrest) and the incident is over. In surrounding environment depiction 450, an authorized command center person 460 is verbally communicating a special password which, when entered into the BWC of the police officer, will constitute the one of the second plurality of actions to stop video recording. Thus, the valid stop request during the second stage may, in some examples, require inputting a secret passcode to the BWC that an assigned user of the BWC does not possess. In some examples, the communication of the special password by the authorized command center person 460 (or a similar person) may be appropriate for other circumstances than as described above. For instance, the above-described communication of the special password might be relied upon by a BWC user in the case of a BWC that does not include an input button to directly stop video capturing.

In accordance with some examples, an at least one processor is configured to identify event severity of one or more of the at least one first trigger and the at least one second trigger as a select one of a plurality of severity levels. In some examples, the severity level may dictate one or more of the following: i) which of the first plurality of actions are suppressed; and ii) which of the second plurality of actions are suppressed. In some examples, the severity level may dictate at least one of access and storage requirements of the persistently stored portions of the pre-record video. For example, a higher assigned severity level may correspond to higher credentials needed to access recorded video, and a lower assigned severity level may correspond to lower credentials needed to access recorded video. Similarly, a higher assigned severity level may correspond to a longer retention period for recorded video, and a lower assigned severity level may correspond to a shorter retention period for recorded video.

A non-exhaustive list of example events that might be categorized as critical or high severity are as follows:
Absence of some critically expected response from the BWC user
Detection of BWC user discharging a weapon
Detection of a gun shot
Unholstering of gun/taser
Analysis of live video that indicates fighting
Analysis of live video, live audio and/or body motion sensor data that indicates scuffling and/or potential fighting
Abnormally delayed response from the BWC user
Cruiser (patrol car) crashed/hit
Man-down detection
Analytics detects a potential felony crime category in progress

A non-exhaustive list of example events that might be categorized as medium severity are as follows:
Analysis of live audio that indicates shouting
Analysis of body motion sensor data (or other data) that indicates that the BWC user experienced a shock or stumbled
Detection of obstruction of the BWC camera view (e.g. obstruction by some threshold percentage)
Detection that the microphone of the BWC is covered/muffled
Cruiser/patrol car switches on light/siren
Analytics detects a potential misdemeanor crime category in progress

A non-exhaustive list of example events that might be categorized as low severity are as follows:
Detection that the speed of the cruiser/patrol car has exceeded a limit (with respect to the current location speed limit)
Detection that cruiser/patrol car door has been opened
Detection that a heart rate of the BWC user has exceeded a preset limit
Detection that the BWC user is running
Detection that the BWC user has entered a specific geographic area or building
Analytics detects a non-criminal infraction category in progress

In at least one example, an officer's response to a command center inquiry can impact a determined severity level. For instance, during a first stage of video recording, a message could be sent from a wirelessly-enabled device of the officer to a command center indicating that artificial intelligence of the BWC is recommending a check directed at the officer as to why the BWC is recording video. The command center then sends an inquiry to the officer as to why that officer's BWC is recording video (for instance, an inquiry in the form of a verbal question sent over a two-way radio communication channel). An “all clear” response from the officer may result in an expected severity level assignment being lowered (or an already assigned low severity level being maintained). Furthermore, in a case where the officer is operating a BWC that does not include an input button to directly stop video capturing, the interaction between the command center and the BWC might serve a dual purpose of allowing the previously herein described special password communication to be carried out in the same interaction. By contrast to the “all clear” case, in a case of no response from the officer (or a duress/covert distress response) an expected result may be severity level assignment being increased (or an already assigned critical or severity level being maintained).

At least some example embodiments disclosed herein may facilitate one or more of the following:
Reduced malicious deactivation of BWC recording
More sophisticated recording control to potentially reduce unintentional persistent storage of BWC video that should not have been recorded (e.g. due to location of recording)
Reduction in problematic impact from a BWC user's accidental pressing of a BWC record button

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot cause data to be stored in non-volatile storage, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server, etc.

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A Body Worn Camera (BWC) comprising:
an image sensor configured to capture video;
a first storage medium configured to temporarily store at least a portion of the video as pre-record video;
a second storage medium configured to persistently store some portions of the pre-record video; and
at least one processor configured to:
initiate a first stage of recording in response to detection of an occurrence of at least one first trigger at a first time,
initiate a second stage of recording in response to detecting or registering an occurrence of at least one second trigger at a second time later than the first time, and
cause the portions of the pre-record video to become persistently stored at a third time after the second time when there is an absence of a valid stop record request during a period of time in-between the first time and the third time,
wherein:
during the first stage defined one or more of a first plurality of actions will produce the valid stop request,
during the second stage defined one or more of a second plurality of actions will produce the valid stop request, and
at least one of the one or more of a first plurality of actions will not produce the valid stop request during the second stage.

2. The BWC of claim 1 wherein each of the one or more second plurality of actions as compared to each of the first plurality of actions requires a higher authorization level to be carried out.

3. The BWC of claim 1 wherein the at least one processor is further configured to implement one or more neural networks to carry out video analytics on the video to generate video metadata that is repeatedly evaluated over time in order to assess whether at least one of the first and second triggers have occurred.

4. The BWC of claim 3 wherein assessing whether the at least one of the first and second triggers have occurred includes evaluating audio metadata in addition the video metadata.

5. The BWC of claim 4 further comprising a microphone that captures audio from which the audio metadata is generated.

6. The BWC of claim 1 wherein the valid stop request during the second stage requires inputting a secret passcode to the BWC that an assigned user of the BWC does not possess.

7. The BWC of claim 1 further comprising a stop button configured to be depressed, and wherein the one or more of a first plurality of actions includes depressing the stop button.

8. The BWC of claim 1 wherein the at least one processor is further configured to identify event severity of one or more of the at least one first trigger and the at least one second trigger as a select one of a plurality of severity levels.

9. The BWC of claim 8 wherein the severity level dictates which of the first plurality of actions are suppressed.

10. The BWC of claim 8 wherein the severity level dictates which of the second plurality of actions are suppressed.

11. The BWC of claim 8 wherein the severity level dictates at least one of access and storage requirements of the persistently stored portions of the pre-record video.

12. A method comprising:
operating an image sensor of a Body Worn Camera (BWC) to capture video;
temporarily storing, in a first storage medium, at least a portion of the video as pre-record video;
initiating, using an at least one processor, a first stage of recording in response to detection of an occurrence of at least one first trigger at a first time;
initiating, using the at least one processor, a second stage of recording in response to detecting or registering an occurrence of at least one second trigger at a second time later than the first time; and
causing a number of portions of the pre-record video to become persistently stored, in a second storage medium, at a third time after the second time when there is an absence of a valid stop record request during a period of time in-between the first time and the third time,
wherein:
during the first stage defined one or more of a first plurality of actions will produce the valid stop request,
during the second stage defined one or more of a second plurality of actions will produce the valid stop request, and
at least one of the one or more of a first plurality of actions will not produce the valid stop request during the second stage.

13. The method of claim 12 wherein each of the one or more second plurality of actions as compared to each of the first plurality of actions requires a higher authorization level to be carried out.

14. The method of claim 12 wherein the at least one processor implements one or more neural networks to carry out video analytics on the video to generate video metadata that is repeatedly evaluated over time in order to assess whether at least one of the first and second triggers have occurred.

15. The method of claim 14 wherein assessing whether the at least one of the first and second triggers have occurred includes evaluating audio metadata in addition the video metadata.

16. The method of claim 15 further comprising capturing audio, by employing a microphone, from which the audio metadata is generated.

17. The method of claim 12 wherein the valid stop request during the second stage requires inputting a secret passcode to the BWC that an assigned user of the BWC does not possess.

18. The method of claim 12 wherein the at least one processor identifies event severity of one or more of the at least one first trigger and the at least one second trigger as a select one of a plurality of severity levels.

19. The method of claim 18 wherein the severity level dictates which of the first plurality of actions are suppressed.

20. The method of claim 18 wherein the severity level dictates which of the second plurality of actions are suppressed.
